(19) United States
(12) Patent Application Publication
(10) Pub. No.: US 2024/0257603 A1
(43) Pub. Date: Aug. 1, 2024

(54) SYSTEMS AND METHODS FOR CARD GAME DATA PROCESSING

(71) Applicant: RF Labs, Inc., Alpharetta, GA (US)

(72) Inventors: Maanit MADAN, Alpharetta, GA (US); Manish MADAN, Alpharetta, GA (US)

(73) Assignee: RF Labs, Inc., Alpharetta, GA (US)

(21) Appl. No.: 18/103,301

(22) Filed: Jan. 30, 2023

(51) Int. Cl. G07F 17/32

(52) U.S. Cl. CPC G07F 17/322; G07F 17/323; G07F 17/3241; G07F 17/3293

(57) ABSTRACT

Systems, methods and computer-readable storage media utilized to create and perform an RF enabled card game table. One implementation includes an RF reader associated with the game table receiving RF signals transmitted by a plurality of RF tags associated with playing cards and chips. The implementation can further include a processor communicatively coupled to the RF reader, the processor rendering a game state from the RF signals, forming and transmitting, via an API, a packet including the rendered game state. RF signals received from an RF tag having a Received Signal Strength Indicator (RSSI) lower than a predetermined threshold can be ignored by the system when a surrounding noise level interferes with transmission of the RF signals and/or the RF tag is disposed at a predetermined distance from the RF readers. RF signals received from an RF tag not affecting the rendered game state can be also ignored by the system.

### BACKGROUND

The present invention relates generally to the field of a Radio Frequency (RF) technology and more specifically to the RF enabled board games using RF tags associated with playing cards and/or chips.

Players of, for example, a multi-handed poker game generally see historical data acquired during the game to have a powerful impact on their decision-making processes. For example, data on past gameplay, including hole card data, bet sizing, timing, position, opponents, and the like, can be utilized to improve a player's decision-making. Typically, in a type of the poker game that is played live, access to historical data is difficult to manually track because of the large number of possible datapoints that may need to be recorded at each stage of a hand.

### SUMMARY OF THE INVENTION

The systems and methods described herein track the historical data in real-time stores it securely, and summarizes it for players to improve their game results. Additionally, these systems and methods can be beneficial for the companies hosting these games because this data can improve operations of these companies.

One implementation of the invention relates to a Radio Frequency (RF) enabled card game table. The game table can include an RF reader associated with the game table receiving RF signals transmitted by a plurality of RF tags associated with playing cards and chips. The game table can include a processor communicatively coupled to the RF reader. The processor can render a game state from the RF signals, form and transmit, via an Application Programming Interface (API), a packet including the rendered game state. In some implementations, RF signals received from an RF tag having a Received Signal Strength Indicator (RSSI) lower than a predetermined threshold can be ignored.

In some implementations, the RF signals received from the RF tag having the RSSI lower than the predetermined threshold can be ignored in response to at least one of a surrounding noise level interfering with transmission of the RF signals or the RF tag being disposed at a predetermined distance from the RF readers. The game table can include an light emitting diode (LED) light associated with a player position, where the processor controls the LED light based on the rendered game state.

In some implementations, the processor can selectively share with other players player data extracted from the received packet. The game table can include a camera communicatively coupled to the processor controlling a camera angle. The game table can include an RF shielding fabric. In some implementations, the RF reader can include an RF antenna that can be spaced apart from other components of the RF reader. In some implementations, the processor is configured to revert a current game state to a prior game state in response to at least one of a user initiating a manual action or the user action creating a legal new outcome. In some implementations, the processor is configured to pause RF reading in response to at least one of a card placed at a center of the game table being manually changed by a user or a reversal from a current game state to a previous game state.

Another implementation of the invention relates to a Radio Frequency (RF) enabled card game table that can include an RF reader associated with the game table receiving RF signals transmitted by a plurality of RF tags associated with playing cards and chips. The game table can include a processor communicatively coupled to the RF reader. The processor can render a game state from the RF signals, form and transmit, via an Application Programming Interface (API), a packet including the rendered game state. In some implementations, RF signals received from an RF tag not affecting the rendered game state can be ignored.

Yet another implementation of the invention relates to a method of using a Radio Frequency (RF) enabled card game table. The method can include receiving, by an RF reader, RF signals transmitted by a plurality of RF tags associated with playing cards and chips. The method can include ignoring RF signals received from an RF tag having a Received Signal Strength Indicator (RSSI) lower than a predetermined threshold. The method can include rendering, by a processor, a game state from the RF signals having the RSSI above the predetermined threshold. The method can include forming, by the processor, a packet including the rendered game state and transmitting, by the processor, via an Application Programming Interface (API), the formed packet.

In some implementations, the method can include ignoring the RF signals received from the RF tag having the RSSI lower than the predetermined threshold in response to at least one of interfering, by a surrounding noise level, with transmission of the RF signals or disposing the RF tag at a predetermined distance from the RF readers. The method can include controlling, by the processor, an LED light associated with a player position in response to the rendered game state. The method can include selectively sharing, by the processor, with other players player data extracted from the received packet. The method can include displaying, by a television screen communicatively coupled to the processor, the rendered game state.

The method can include controlling an angle of a camera communicatively coupled to the processor. In some implementations of the method, the RF reader can include an RF antenna. In some implementations of the method, the RF antenna can be spaced apart from other components of the RF reader. The method can include reverting, by the processor, a current game state to a prior game state in response to at least one of a user initiating a manual action or the user action creating a legal new outcome. The method can include pausing, by the processor, RF reading in response to at least one of a card placed at a center of the game table being manually changed by a user or a reversal from a current game state to a previous game state.

### BRIEF DESCRIPTION OF THE DRAWINGS

FIGS. 1A-1C are RF enabled systems, according to some embodiments of the present disclosure.

FIG. 2 is an RF enabled system, according to another embodiment of the present disclosure.

FIGS. 3A-3C are RF enabled systems, according to yet some other embodiments of the present disclosure.

FIG. 4 is an RF enabled system, according to yet another embodiment of the present disclosure.

FIG. 5 is a block diagram illustrating an example computing system suitable for use in the various arrangements described herein.

It will be recognized that some or all of the FIGS. are schematic representations for purposes of illustration. The FIGS. are provided for the purpose of illustrating one or more embodiments with the explicit understanding that they will not be used to limit the scope or the meaning of the claims.

### DETAILED DESCRIPTION

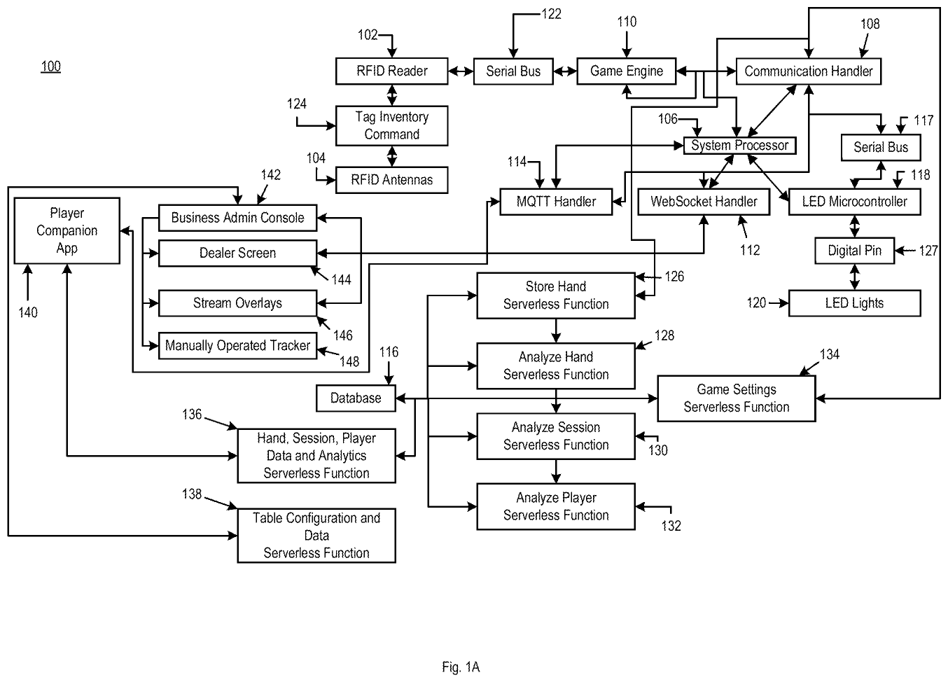

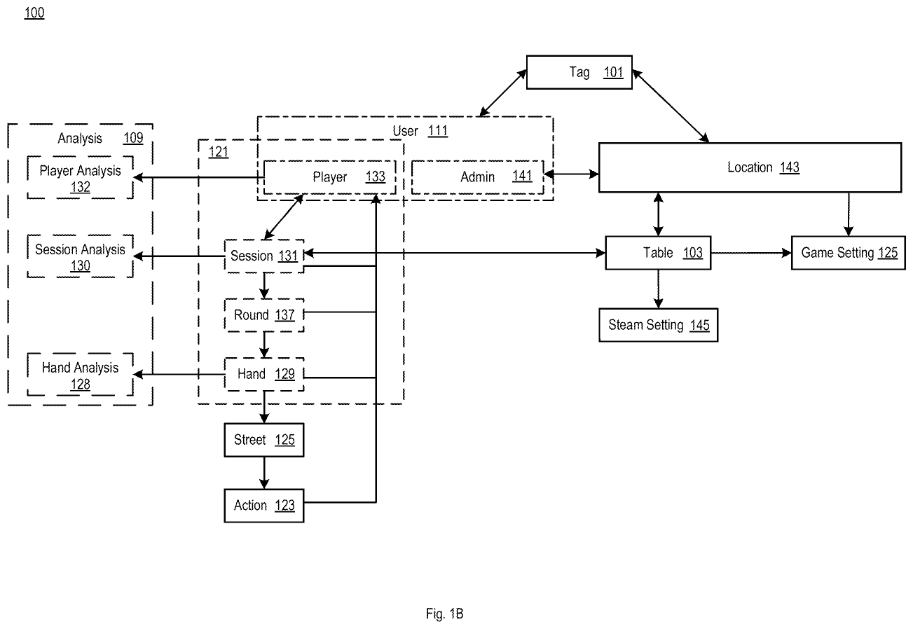

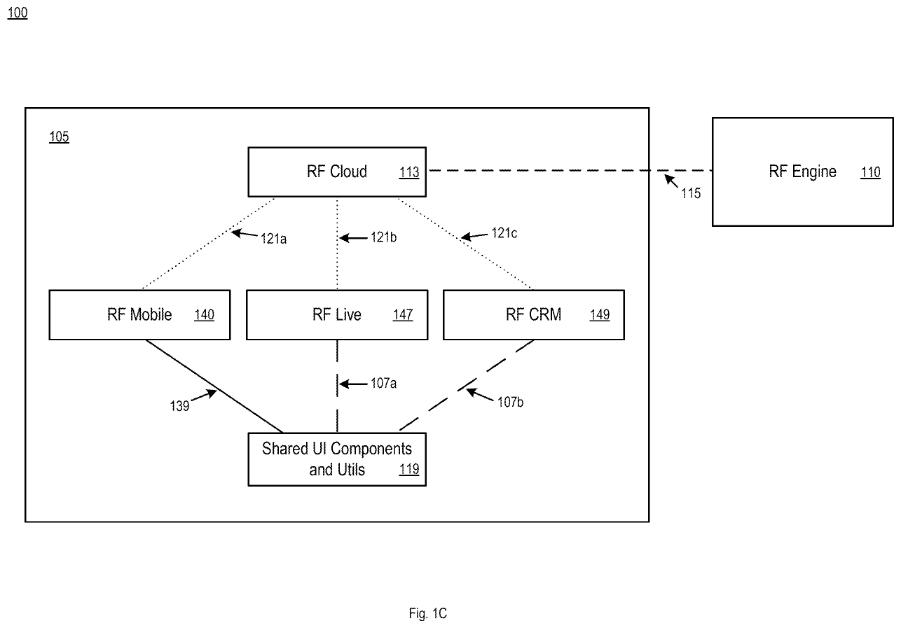

Referring to FIGS. 1A-1C, block diagrams depicting an example of a Radio Frequency (RF) enabled system 100 are illustrated, according to some implementations. RF is alternatively or optionally referenced herein as RF identification (RFID). The RF-enabled system 100 includes a physical table having a top surface. As shown in FIG. 1A, the RF enabled system 100 includes a computing system having a system processor 106 communicatively coupled to a communication handler 108, a game engine 110, a WebSocket handler 112, and a Message Queuing Telemetry Transport protocol (MQTT) handler 114, according to some implementations. The computing system includes a database 116 that can be communicatively coupled to the communication handler 108. In some implementations, the computing system can be disposed underneath table or hosted remotely.

In some implementations, the game engine 110 is communicatively coupled to the RF reader 102 that may be coupled to an RF antenna 104. During operation, the RF reader 102 scans in present cards and chips and transmits data to the game engine 110 that can check for data stored in the database 116. Based on the transmitted data, the game engine 110 can determine various parameters of a game, for example, a rendered game state, number of players, bet sizes, and the like. The system processor 106 can analyze such parameters and send a command to a light emitting diode (LED) microcontroller 118 communicatively coupled to the LED lights 120 to display the color predetermined for the rendered game state, where the color can depend on a player position, a player action, and the like.

In some implementations, the WebSocket handler 112 can send a command to display analytical and other data to a player companion application 140, a dealer's screen 144, and/or a stream overlay 146. In some implementations, the player companion app 140 can be installed, for example, on a user's device. In some implementations, the stream overlay 146 can be communicatively coupled to other components of a broadcasting system to display, for example, a live stream.

In some implementations, RF readers 102 (or scanners) are disposed under the top surface of the table. The RF readers 102 can read RFID tags 101 that can be stacked in multiple layers. Such reading of the RF tags 101 by the RF readers 102 occurs in real-time at high speed. The RF readers 102 communicate with a system processor 106 that can be disposed on-board the table or that may be remotely hosted.

In some implementations, the RF tags 101 are associated with playing cards and chips. For example, the RF enabled system 100 can include poker chips, cards, dealer button position, and other miscellaneous cards (e.g., all in, sit out, missing blinds, cut card, and the like) that are embedded with RFID tags 101. The RF tags 101 can be encoded with unique serial numbers. The RF enabled system 100 enables players to interface with the table using the same natural hand movements they would use when playing a poker game. Additionally, the RF enabled system 100 automatically tracks, stores, and analyzes a physical gameplay in its entirety or partially.

Reference is now made to the hardware architecture and structure of the RF enabled system 100. In some implementations, the RFID embedded chips can be formed of a ceramic material. The RF chips can weigh 12 grams, operate according to the ISO/IEC 15693 protocol, having an embedded integrated circuit chip ICODE® SLIX, such as those supplied by Ningbo Flyers Leisure & Sporting Company of Ningbo, China.

In some implementations, the RFID embedded cards can operate according to the ISO/IEC 15693 protocol, having an embedded integrated circuit chip ICODE® SLIX, such as those supplied by Shenzhen RZX Technology Company of Shenzhen, China.

In some implementations, the RF reader 102 includes a housing, an integrated circuit RF chip (or microprocessor), an RF antenna 104, a power source (such as, for example, a battery), a transmitter, a receiver, and/or transceiver that operate in high-frequency range, for example, between 3 MHz and 30 MHz. For example, the RF reader 102 can operate at 13.56 MHz frequency. Signals transmitted by the RF tags 101 may be received by the RF reader 102 and can have a range of signal strength values, generally referred to as the Received Signal Strength Indicator (RSSI). The RF reader 102 can include a microprocessor to process the received signals and communicate with the game engine 110, the system processor 106, and other components of the RF enabled system 100. For example, the microprocessor of the RF reader 102 can be communicatively coupled to the game engine 110 via a serial bus to transmit packets containing information about the processed signals, for example, the RSSI of the signals received from the RF tags 101. In some implementations, the RF readers 102 can include Bluetooth Low Energy (BLE) transmitters. For example, the RFID tags 101 can be interrogated by the RF readers 102 and the data packets formed of the data retrieved from the RF signals is transmitted by the BLE transmitters via Bluetooth connection to the game engine 110 and/or other components of the RF enabled system 100.

In some implementations, the RF tags 101 can be active or passive. The active RF tag can correspond at least partially in one or more of structure and operation to the RF reader 102. For example, the active RF tag can have a housing or substrate for disposing other components of the RF tag. The passive RF tag can correspond at least partially in one or more of structure and operation to the active RF tag, except that the passive RF tag may not have a power source. In some implementations, RF signals received from the RF tag having the RSSI lower than the predetermined threshold can be ignored by the RF reader 102, the game engine 110, the system processor 106, and/or other components of the RF enabled system 100. In some implementations, the predetermined value of the RSSI of the RF signals (i.e., below which threshold the tag associated with the RF signals can be ignored) can be in a range between 1600 and 3200. In some implementations, the threshold of RSSI strength when the signal is to be ignored is calibrated based on the analysis of noise signals received by antenna. In some implementations, the following method can be used to perform the calibration procedure. For example, the RFID card can be placed at the center of each RF antenna 104 and a range of the RSSI values is determined with a set average value and standard deviation that can be used to filter certain RF tags 101. In some implementations, the calibration of the RSSI threshold can be performed automatically via, e.g., a software.

In some implementations, the RF signals can be ignored if a surrounding noise level interferes with transmission of the RF signals. Alternatively or optionally, the RF signals can be ignored when the RF tag is disposed at a predetermined distance from the RF readers 102. In some implementations, predetermining the distance from the can correspond at least partially in one or more of structure and operation to the calibration process described above. For example, the RFID card can be placed at the center of each RF antenna 104 and a range of the RSSI values is determined with a set average value and standard deviation that can be used to filter certain RF tags 101. In some implementations, this predetermining the distance for ignoring of the certain RF tags 101 can be performed automatically via, e.g., a software. In some implementations, the RF tags 101 associated with the antennae 204 that do not affect the game state can be ignored as well. For example, if a player folds the player's cards, then the RF tags 101 associated with the chips belonging to that player can be ignored by the processing components of the RF enabled system 100.

In some implementations, the RF reader 102 can have the RF antenna 104 within the same housing of the RF reader 102 where other components of the RF reader 102 (e.g., the receiver, the transmitter, the microcontroller, etc.) are disposed. In some implementations, as illustrated in FIG. 1A, the RF antenna 104 can be spaced apart from the other components of the RF reader 102. For example, there can be several RF antennae 104 while only one RF reader 102 communicatively coupled with the plurality of the RF antennae 104. In some implementations, an input and an output of a tag inventory 124 is communicated between the RF reader 102 and the RF antennae 104.

In some implementations, the RF enabled poker table can include twelve RFID antennae 104. In some implementations, the RFID reader 102 can be a high-speed RF reader that can, for example, include twelve ports operating at a high frequency of 13.56 MHz. The RF reader 102 can communicatively couple, via the twelve ports, with the twelve RF antennae 104 that are spaced apart from the RF reader 102. The RF antenna 104 can be a square, e.g., 9 inches by 9 inches, operating in high-frequency 13.56 MHz. Exemplary RF readers include those supplied by GAO RFID, Inc. of New York, U.S.A.

In some implementations, the RF enabled system 100 can include a so-called Faraday fabric protecting penetration of electric and magnetic fields (EMF) from one side of a Faraday fabric to the opposite side. The Faraday fabric (e.g., the RF shielding fabric or the RF blocking fabric) can have a sufficient conductivity to block or substantially reduce an electromagnetic radiation from escaping from one side of the RF shielding fabric to another side of the RF shielding fabric. The RF shielding fabric can be disposed around the RF antennae 104 to prevent or substantially reduce the undesired RF signals. For example, when the table includes the RFID blocking fabric underneath the top layer and/or around the outside perimeter of the RF antennae 104, the RF signals sent by the RF tags 101 associated with the block chips in the player stacks are prevented from being accidentally read. In some implementations, the RF shielding fabric can be the Faraday fabric having a military grade, such as those supplied by Alfredx via Amazon, Inc. of Seattle, U.S.A.

In some implementations, the RF enabled system 100 can include the LED Lights 120 that can be disposed inside the inner circumference of the table peripheral support for player arms. The LED lights 120 can be controlled by the LED microcontroller 118 and communicatively coupled to the LED lights 120 via a digital pin connection 127. In some implementations, the LED lights 120 can be arranged in an addressable LED lights strip (or string). For example, it can be an addressable LED lights string WS2811, such as those supplied by Rextin via Amazon, Inc. of Seattle, U.S.A.

In some implementations, the RF enabled system 100 can include the dealer tablet 144 (or the dealer screen) that can be separable or embedded in the RF-enabled poker table for a dealer to coordinate various game phases. In some implementations, the RF enabled system 100 can include a television (TV) screen that can be communicatively coupled to other components of the RF enabled system 100, for example, the system processor 106, the communication handler 108, the WebSocket handler 112, and the like. The TV screen can be removably coupled to the RF-enabled poker table and can display the rendered game state.

In some implementations, the RF enabled system 100 can include a broadcasting system that can further include a camera. In some implementations, the camera can include a switcher (or a camera switcher) that can be removably coupled to the table. In some implementations, camera is configured to receive instructions to turn the camera at specific angles in a three-dimensional Cartesian coordinate system. Such instructions can be received by the switcher from the processing components of the RF enabled system 100, for example, from the WebSocket Handler 112.

Reference is now made to components of the software architecture and structure of the RF enabled system 100. In some implementations, the RF enabled system 100 can include the computing system that can further include the game engine 110. The game engine 110 can include one or more processors (e.g., any general purpose or special purpose processor), and include and/or be operably coupled to one or more transitory and/or non-transitory storage mediums and/or memory devices (e.g., any computer-readable storage media, such as a magnetic storage, optical storage, flash storage, RAM, and so on). In some implementations, the game engine 110 can run the Python programming language or the like.

In some implementations, the TV screens, the dealer tablet screens 144, and stream overlays 146 can be programmed in a React JS web application (for example, in Next.JS framework). In some implementations, the TV screens, stream overlays, and dealer tablet screens 144 can be communicatively coupled via WebSocket protocols to the game engine 110 (that can run the Python programming language). In some implementations, the LED lights 120 are controlled by the LED microcontroller 118 that can be programmed in C++ programming language or the like.

A brief reference is now made to a backend architecture that can be, for example a cloud backend. In some implementations, when sending or requesting data packets from the backend, the communication handler 108 and/or other components of the RF enabled system 100 makes an API call using, for example, TypeScript Remote Procedure Call (tRPC), Representational State Transfer (REST) API request for Python, or GraphQL functions using the locally stored API Key.

In some implementations, the RF enabled system 100 can include the database 116 (that can be, for example, a DigitalOcean database). In some implementations, the database 116 can be in the cloud; the data from the database 116 can be retrieved remotely. In various implementations, the database 116 includes various transitory and/or non-transitory storage media. The storage media may include magnetic storage, optical storage, flash storage, and RAM. The database 116 can use various APIs to perform database functions (e.g., managing data stored in the database 116). The APIs can include SQL, NoSQL, NewSQL, ODBC, and/or JDBC components.

FIG. 1B illustrates data entry and processing in the database 116 that can be, for example, in the cloud backend. In some implementations, each user 111 can be assigned as a player 133 or an administrator 141 (that is associated with the business enterprise or location 143 where the card game table 103 is commissioned). The user 111 can have access to own user hands 129, sessions 131 and analytics 109, and/or to the location tables 103, sessions, and settings (for example, game settings 135 and/or stream settings 145). For example, when a round of hands 129 is stored in the backend, the data is stored and processed using the serverless functions (that can be, for example, Vercel serverless functions).

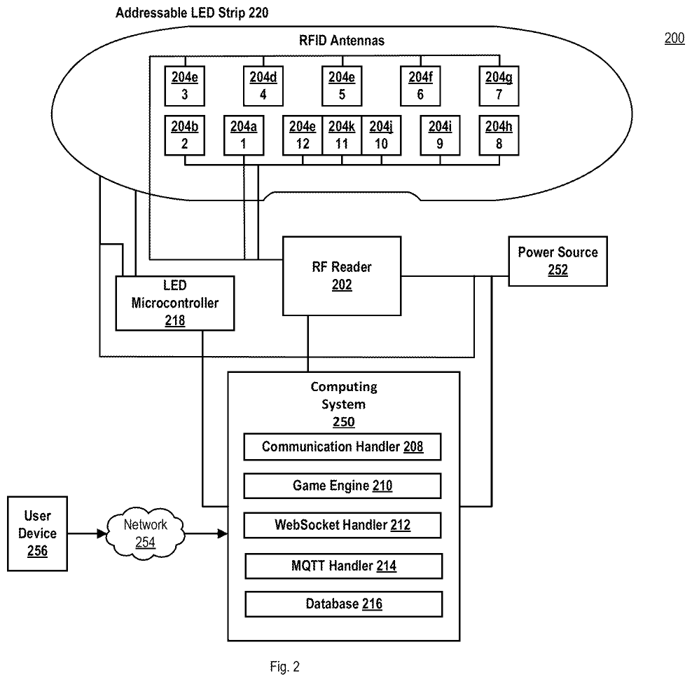

In some implementations, the serverless functions can provide the analytics 109. For example, the serverless functions can be store a hand serverless function 126, an analyze hand serverless function 128, an analyze session serverless function 130, an analyze player serverless function 132, a game settings serverless function 134, a hand, session, player data and analytics serverless function 136, and a table configuration and data serverless function 138. In some implementations, the RF enabled system 100 can include object relational mapping (ORM), for example, EdgeDB ORM. In some implementations, a structure of the database 116 can be in a form of a relational database, for example, EdgeDB PostgreSQL. The database 116 can be communicatively coupled via ORM to one or more of the hand serverless function 126, the analyze hand serverless function 128, the analyze session serverless function 130, the analyze player serverless function 132, the game settings serverless function 134, the hand, session, player data and analytics serverless function 136, and the table configuration and data serverless function 138. In some implementations certain data 121 of the player 133 can be shareable. For example, such shareable data 121 may include the session 131, the round 137, and the hand 129. Other data associated with the player 133 can include a street 125 and an action 123. In some implementations, the session analysis 130 and/or hand analysis 128 can be updated live via the computing system 250 (FIG. 2).

In some implementations, command line utilities such as cronjob queries for sessions 131 can be coded as following: “processed” as false and “processing” as false. If the last updated timestamp in the session 131 is greater than a fixed time constant, then setting for “processing” can be as true and run, for example, a session processing cloud function to process the session 131 into the player data (for example, PlayerDatum). On completion, the parameters are set for “processed” to true and “processing” to false. In some implementations, after the session 131 ends, the player data can be updated in the backend (that can be in the cloud). Performance of analytics 109 using the serverless functions 126, 128, 130, 132, 134, 136, and 138 facilitates a faster (as compared to data processing in typical card game table systems) and optimal retrieval of the analytics 109 in a mobile application 140.

In some implementations, the analysis 109 can be performed by a mobile application 140 (or player companion application). In some implementations, the mobile application 140 can be written in the React Native programming language, that can be deployed via an application service (for example, via Expo) for various operating systems, for example, for iOS and Android. In some implementations, a JS code (for frontend and/or backend) can be hosted in a repository, for example, in MONOREPO.

FIG. 1C illustrates data flow between certain components of the RF enabled system 100. Monorepo or any other common repository strategy 105 can include all typesafety applications, APIs, and/or shared utilities.

The MONOREPO components can include the API 113 (or RF Cloud, that can be, for example, Fastify TRPC API), mobile application 140 for players (or RF Mobile, that can be, for example, Expo), web application 147 for the live streams (or RF Live), web application 149 for businesses (RF Customer Relationship Management (RF CRM)), and the user interface (UI) components and utilities/packages 119 that are shared between these components of the RF enabled system 100. RF live 147 and RF CRM 149 can be, for example, in React Framework and be communicatively/and or electrically coupled to the shared UI components and utilities 119 via a React Native Web adapter 107 a and 107 b. In some implementations, the RF Mobile 140 can be communicatively/and or electrically coupled to the shared UI components and utilities 119. The RF Cloud 113 can be communicatively/and or electrically coupled to the RF Mobile 140, the RF Live 147, and the RF CRM 149 via end to end Typesafety via, for example, TRPC Client.

The RF Cloud 113 can be communicatively/and or electrically coupled to the RF Engine (that can be, for example, the game engine 110) to transmit and receive data that is not Typesafety; the data can be sent via REST API via, for example, TRPC OpenAPI adapter. When the RF Engine 110 from the game table 103 sends the data to the RF Cloud 113, e.g., via REST API, the data is stored via EdgeDB in the database 116 (that can be, for example, a DigitalOcean database). In some implementations, the serverless functions 126, 128, 130, 132, 136, 136, and 138 are run. In some implementations, the other applications in MONOREPO can access the data from the API and display the data via the UI components using the shared utilities and components in MONOREPO. The RF CLOUD 113, the RF MOBILE 140, the RF LIVE 147, the RF CRM 149, and the RF ENGINE 110 can be such as those supplied by RF Labs, Inc. of Atlanta, U.S.A.

In some implementations, when the players and the dealers play on the table using physical the RFID embedded chips and cards, the computing system (that can be, for example, an onboard computing system) sends the tag inventory 124 continuously to the RFID reader 102 via a serial bus. In some implementations, the RFID reader 102 scans the tag inventory 124 for each RFID antenna 104 and returns unique identifiers of the RF tags 101, for example, serial numbers of the tags 101 and their respective RSSIs.

In some implementations, the onboard computing system decodes the tag inventory 124 and checks associated tag types with the types stored, for example, in the database 116. In some implementations, the onboard computing system runs the game engine loop and communication loop continuously to process a current game state and send the current game state packet to external interfaces. In some implementations, the game engine loop can be executed, for example, by the game engine 110 that can be, for example, communicatively coupled to the RF reader 102 via a serial bus 122. In some implementations, the communication loop can be executed by the communication handler 108 that can retrieve the current game state and send the data packet to the external interfaces. The external interfaces can include, for example, the LED controller 118, the dealer tablet 144, a business administrator console 142 controlled by an operator of the business enterprise where the RF enabled system 100 is commissioned, user devices of viewing audience, and the like.

In some implementations, after the game engine loop completes a hand, then a hand history, a player metadata, and a hand metadata are sent to the cloud backend via Application Programming Interface (API). In some arrangements, the one or more processing circuits can establish, utilizing the API, a data feed associated with the hand and can monitor the data feed including executing API calls with the API, where the API calls return the data and update the database 116.

In some implementations, the API can be, for example, a private API. In various arrangements, the private network may be implemented based on a private network protocol such as Internet Protocol Security (IPSec), Layer 2 Tunneling Protocol (L2TP), Point-to-Point Tunneling Protocol (PPTP), Secure Shell (SSH), and the like. In some arrangements, each individual table can be provided with a private IPV4 address and/or a private IPV6 address.

For example, an exchange interface of the one or more processing circuits of the computing system can establish a secure connection over a secure network. That is, the secure connection can allow for secure communication and secure transfer of data to/from the one or more processing circuits over a secure network (e.g., secure VPN connection, secure wired connection, and so on) utilizing a secure network protocol (e.g., Secure Shell (SSL), Kerberos, IPSec, Secure Sockets Layer (SSL), Hypertext Transfer Protocol Secure (HTTPS), and so on).

In various arrangements, any data shared and/or accessed over network may be encrypted and/or secured (e.g., hashed, password protected) to prevent unauthorized parties from performing unauthorized actions in the computer network environment. For example, a masking algorithm may be executed performing bitwise operations (e.g., NOT, AND, NAND, OR, XOR, Complement, left-shift (logical or arithmetic), right-shift (logical or arithmetic), rotate right, rotate left, and so on) on the addresses, digital assets, or any data transferred over network.

In some implementations, a cloud backend using the store hand serverless function 126 stores the original hand history in the database 116. For example, the communication handler 108 and the store hand serverless function 126 can make the API calls to transfer between each other the data packets related to the hand history. In some implementations, the cloud backend runs the hand analyzer serverless function 128 that processes the hand history and stores statistical values (or statistics) for each player for that given hand. Then, the cloud backend can run the session analyzer and player analyzer serverless functions, 130 and 132, respectively, to add the statistical values to session analytics and player analytics.

In some implementations, when the player or business enterprise operating the RF enabled system 100 opens the mobile and/or web-network application (for example, the player companion application 140 or the application running on the business administrator console 142), the player, session, and hand analytics are retrieved and displayed via graphs, charts, hand transcripts, individual statistics, and scores that can be, for example, arbitrary.

In some implementations, the player can share the player's analytics and statistics when this player provides an access to specific data points to other players. For example, specific data points can be the data points of this player. In some implementations, these data points can be stored in the backend.

Reference is now made to a communication process between various components of the RF enabled system 100. In some implementations, the WebSocket Handler 112, the MQTT handler 114 for real-time notifications, the cloud backend, the LED microcontroller 118, and the camera switcher can implement the communication process of the RF enabled system 100.

In some implementations, the WebSocket Handler 112, for example, sends every 50 milliseconds to the business administrator console 142, the dealer screen 144 and the stream overlays 146, and/or a gaming channel (for example, the World Sports Stream channel) a packet that can contain a current game data. If a WebSocket message is received from the WebSocket Handler 112, the system processor 106 checks the event route and executes a corresponding method in the game engine 110 based on the received data.

In some implementations, the data stored in the database 116 may include personal information (e.g., names, addresses, phone numbers, and the like), and/or authentication information (e.g., username/password combinations, device authentication tokens, security question answers, unique client identifiers, biometric data, geographic data, social media data, and the like), relating to the various users. In some implementations, the WebSocket Handler 112 can be configured such that WebSocket Handler 112, when sending the data packet to the gaming channel, does not include data about hole cards and sensitive privacy data, for example, phone numbers of the players. In some implementations, an administrator using, for example, a business administrator console 142 can send an unlock request, for example, to the cloud backend, and, after being verified as the administrator, can be authorized to unlock the game engine 110. In some implementation, verifying can also include using a two-factor authentication. For example, the one or more processing circuits can send a notification to the business administrator to confirm the request is valid and associated with the administrator. If the game engine 110 is unlocked using, for example, two verification codes from the administrator, then the data about the hole cards and/or sensitive privacy information of the players can be included in the packet.

In some implementations, the MQTT handler 114 can execute real-time notifications. In some implementations, the MQTT handler 114 can be communicatively coupled to the player companion application 140 via a join game communication channel. For example, if a user searched a status of the table and an MQTT event is triggered, the MQTT handler 114 sends to the user the data packet containing information about the current open seats at the table. In some implementations, the MQTT event can be a join game event when, for example, players information can be sent from player companion application 140 to the table game engine 110. In some implementations, the MQTT event can be a table start event when, for example, starting up of the table game engine 110 notifies customer support team providing the customer support team with diagnostics data.

In some implementations, if the game code event is triggered, the MQTT handler 114 checks the received data for the player's seat number, name, phone number, and stack size, and store that player's information in the game parameters. When the game engine 110 initiates the game mode, the MQTT handler 114 sends a heartbeat message to confirm the game engine 110 is enabled with the current settings.

Reference is now made to a serial bus 117 that communicatively couples the LED Microcontroller 118 and the communication handler 108. In some implementations, the communication handler 108 commands the LED Microcontroller 118 to set the LED lights 120 to certain colors via, for example, sending through the serial bus 117 an array of integers (each number corresponding to a certain color for that section of the addressable LED strip 220 (FIG. 2).

Reference is now made to the camera switcher communicatively coupled to the camera. In some implementations, the camera switcher can set the current program output by controlling the camera. In some implementations, the camera switcher can be communicatively coupled to the camera by using an IP address of the camera switcher on the same network. In some implementations, the camera switcher can be, for example, a Blackmagic ATEM® switcher, open broadcaster software (OBS) WebSocket, or the like. The Blackmagic ATEM® switcher can be a camera switcher such as those supplied by Blackmagic Design of Port Melbourne, Australia.

Reference is now made to a process of scanning and storing the RFID tag signals. In some implementations, the scanning and storing process includes reading by the game engine 110, via the serial bus 122, a tag inventory output from the RFID reader 102. In some implementations, the game engine 110 parses through each RF tag on each RF antenna 104. In some implementations, the game engine 110 checks the database 116 for an RF tag unique identifier, for example a serial number of the RF tag and an associated RF tag type. The RF tag types can include, for example, a chip, a card, a player ID, an “all in” card, a “sit out” card, “missing blinds” card, and the like. In some implementations, the game engine 110 stores the tag type for each RF antenna 104 in a separate list of currently processed tag inventory 124. In some implementations, the game engine 110 can repeat the scanning process after all RF antennae 104 are scanned by the RF reader 102.

FIG. 2 illustrates one of the implementations of the present disclosure illustrating hardware structural components of the RF enabled system 200. The RF enabled system 200 may be identical to or similar in some respect to the RF enabled system 100 of FIG. 1A. Accordingly, like features may be designated with like reference numerals, with the leading digits incremented to “2”. Relevant disclosure set forth above regarding similarly identified features thus may not be repeated hereafter. Moreover, specific features of the RF enabled system 200 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the RF enabled system 200. Any suitable combination of the features and variations of the same described with respect to the RF enabled system 100 can be employed with the RF enabled system 200, and vice versa. This pattern of disclosure applies equally to further embodiments depicted in subsequent figures and described hereafter.

In some implementations, the system 200 can include twelve RFID antennae 204a through 204l disposed under the top surface of the table. The RF antennae 204a through 204l are disposed such that at least one antenna 204a through 204i is in front of each player and located in front of the betting line to read bets and hole cards when the cards are dealt. In some implementations, additional player antennae (not shown) can be disposed behind the betting line to isolate certain cards and chips. Also, three antennae 204j, 204k, and 204l can be disposed at the center of the table to read community cards, the pot, and any muck cards.

In some implementations, the RFID reader 202 is disposed underneath the table and communicatively coupled to twelve RF antennae 204a through 204l. In some implementations, an LED controller 218 (or microcontroller) is disposed underneath the table and connected to LED lights 220 that may be formed as an addressable light strip 220.

In some implementations, a computing system 250 that may include a system processor 206, a game engine 210, a communication handler 208, an MQTT handler 214, a WebSocket handler 212, and a database 216. In some implementations, the computing system 250 may run a Linux operating system and may be disposed underneath the table and communicatively and/or electrically coupled to the RFID reader 202 and the LED microcontroller 218, for example, via a USB connection. The RF enabled system 200 can include a power source 252 that can supply power to the RF reader 202, the RF antennae 204, the LED microcontroller 218, the LED lights 220, and the computing system 250. The power source 252 can be a source of electrical power supplied from the wall and/or floor electrical socket. Alternatively or optionally, the power source 252 can be a stand-alone battery. The computing system 250 is connected to a network 254 (that can be, for example, the internet) via a wired ethernet connection and/or a built-in Wi-Fi adapter. A user device 256 can be communicatively coupled to the network 254.

The user device 256 can be an electronic device that is under control of a user (e.g., a player) and is capable of sending/receiving requests and resources/data (e.g., user preference data, user device identifiers, session identifiers, layout data, content items, historical data) over communication network 254. Example user device 256 include personal computers (e.g., desktop or laptop), mobile communication devices (e.g., smartphones or tablets), video game console, servers, and other devices that can send and receive data over communication network 254. User device 256 includes (or executes) the player companion application 140 of FIG. 1A, such as an internet/web browser, a graphic user interface (GUI), an email reader/client, and a File Transfer Protocol (FTP) client, or the player companion application 140 independent from an internet/web browser), to facilitate the sending and receiving of data between user device 256 and computer system 250, via communication network 254. User device 256 renders the data within/via the player companion application 140 or may include (or execute) other content rendering applications (e.g., pdf viewer, doc viewer, txt viewer, xls viewer, ppt viewer, HTML viewer, jpg/bmp/png viewer, video viewer) to display the received data on a display screen.

User device 256 is communicatively coupled to the computer system 250 via a communication network 254. The communication network 254 is any suitable Local Area Network (LAN) or Wide Area Network (WAN). For example, the communication network 254 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The communication network 254 is structured to permit the exchange of data, values, instructions, messages, and the like between the user device 256 and the computing system 250. Although not illustrated, in many implementations, communication network 254 may comprise one or more intermediary devices, including gateways, routers, firewalls, switches, network accelerators, Wi-Fi access points or hotspots, or other devices.

Reference is now made to a game configuration that includes settings configurable, for example, in the backend, that can be, for example, in the cloud. In some implementations, the game configuration settings can be set for each game variation. The RF enabled system 200 can execute the game configuration before starting a game.

In some implementations, a game mode (for example, a cash game, a final table, a sit-n-go, and the like mode) can set parameters for a structure of the game and a type of statistics that can be recorded and displayed. In some implementations, a game variation (“No Limit Hold'em”, “Pot Limit Omaha”, “Hi-Lo”, and the like) can set parameters for a number of mandatory hole cards, a number of boards, a ranking of hand classes, requirements to have a winning hand or splitting the pot, and a number of draws. In some implementations, blind levels (for example, a blind, straddle, and/or ante for each position, and the like blind levels) can be also configured as multiple levels that can repeat during the game.

In some implementations, a table configuration can include a number of seats in the table, port identifications (IDs) of a universal serial bus (USB), broadcast settings, and/or sensitivity limit thresholds of the RSSI calibrated for the table (for ignoring RF tags 101). The number of seats in a table (or capacity) can determine a plurality of the antennae 204. For example, in a nine-handed table, the RF enabled system 200 can include twelve antennae: nine antennae 204a through 204i (for the players) and three antennae 204j, 204k, and 204l at the center of the table (for example, to recognize the community cards). In some implementations, the USB port IDs can include the port IDs for the computing system 250 and the LED controller 218. In some implementations, the broadcast settings for the tables where the camera switchers are communicatively coupled to record videos of the game. In some implementations, the sensitivity limits can be calibrated for a certain table so that the RF readers 202 associated with that specific table can be configured to ignore signals received from the RF tags 101 based on a certain distance of the table from the RF tags 101 of the playing cards and chips associated with another table and/or based on surrounding noise levels. In some implementations, the RF tags 101 associated with the antennae 204 that do not affect the game state (e.g., the antennae 204 of the players who folded the player's cards) can be ignored as well. In some implementations, the table configuration and data serverless function 138 (FIG. 1A) and the business administrator console 142 (FIG. 1A) can make the API calls using, for example, tRPC, to transfer between each other the data packets related to the table configuration and data.

Reference is now made to various modes of the RF enabled system 200 that the game engine 210 can execute, for example, a setup mode, a standby mode, a play mode, a clearing mode. In some implementations, the game engine 210 runs a game engine loop that can follow, for example, the following steps. In some implementations, at starting up of the RF enabled system 200, the game engine 210 reads game settings 135 from the backend in the cloud, processes the game settings 135, sends a signal to the backend in the cloud with a new game code, initializes the RFID Reader 202, starts the communication process, and sets the game mode to a SETUP mode. In some implementations, the game engine 210 checks the RFID tag inventory 124 and stores a current state and the unique identifiers of the current RF tags 101 whose signals are received by the RF antennae 204.

Reference is now made to the SETUP Mode. In some implementations, the RF enabled system 200 can be in a waiting phase, awaiting for players to join the game. If, for example, a Player ID card is present on one of the first nine antennae 204a through 204i (e.g., player betting spots), then the game engine 210 executes a search for a player ID in the database 216 (that can be, for example, in the cloud) for a player ID and sets that seat as being associated with that player (via, e.g., a phone number, a user ID, an email, or a name of the player). In some implementations, if the chips are present on one of the antennae 204a through 204i, the game engine 210 sets for the players a starting stack size (stack and buy-in).

In some implementations, if a player (e.g., a user) uses the mobile application (for example, the player companion application 140 of FIG. 1A) to join the game via, for example, a code setup by the communication process, then the game engine 210 sets that user to that seat including the player's name, profile picture, and starting stack size. In some implementations, when at least two players are seated, the game engine 210 sets the current game mode to the STANDBY mode.

Reference is now made to the STANDBY Mode. In some implementations, the RF enabled system 200 can be in a phase between hands when waiting for the cards to be dealt. In some implementations, the game engine 210 parses through each player antenna 204a through 204i (e.g., antennae associated with a player 1 through player 9), and checks the database 216 if any of the present RF tags 101 are of playing card type (AS, 2S, 3S, . . . , QD, KD). In some implementations, the game engine 210 stores the recognized card in the players hand temporarily.

In some implementations, if the game engine 210 finds a card being on an RF antenna 104 that was previously on a different player's antenna, then the game engine 210 adds that specific card to the new player's hand and removes it from the previous player's hand. In some implementations, the game engine 210 remembers the movement by adding this card to a separate list on both players' hands for a backup. Such separate list can be stored locally, for example, in a temporary memory, e.g., as a variable.

In some implementations, when each player receives a predetermined number of mandatory hole cards, the game engine 210 sets in this game configuration (for example, two hole cards for the “No Limit Hold'em” games, four cards for the “Pot Limit Omaha” games). In some implementations, the game engine 210 starts the hand by setting the game to the PLAY mode.

In some implementations, if the dealer or operator forces a start, the game engine 210 sets the missing cards to a blank XX card and/or checks if there are any previously read cards in the backup list, and sets the game to the PLAY mode. In some implementations, if a tag associated with a “cut card” is present in the center of the table (e.g., associated with the antennae 204j, 204k, and 204l associated with the antenna positions 10 through 12), then the game engine 210 clears all hands because this is the result of a misdeal or an accidental card being read and the dealer shuffles.

In some implementations, during the STANDBY mode, players can be added, removed, and edited (for example, the players' stack size, sit out, and the like parameters can be modified). In some implementations, the game engine 210 can change the game configuration temporarily or permanently.

In some implementations, during the STANDBY mode, the LED microcontroller 218 can instruct the following light modes to the LED lights 220: off, white, green, and blue. For example, the “off” mode of the LED light 220 indicates that a player is not in hand. For example, the “white” mode of the LED light 220 indicates cards are not read but a player is in hand. For example, the “green” mode of the LED light 220 indicates cards are read and a player is in hand. For example, the “blue” mode of the LED light 220 indicates cards are not read and a player is the dealer.

Reference is now made to the PLAY Mode. In some implementations, the game engine 210 tracks action throughout the game. For example, for each player, the game engine 210 stores the player's state if the player is in the hand (e.g., not sitting out with a stack greater than zero), the current chips placed on the antenna 204a through 204i, the player's hole cards registered in STANDBY mode, the player's position relative to the dealer button position, the player's current hand equity, the player's committed bet on the current street, and whether or not the player had option to bet on the current street.

In some implementations, if the current street has a PREFLOP status, the game engine 210 sets the starting action to the player after the blinds. In some implementations, if the current street is POSTFLOP (e.g., FLOP, TURN, or RIVER) the game engine 210 sets the starting action to the player after the dealer button position.

In some implementations, when a new bet is detected from chips on the player antenna 204a through 204i, or a bet is manually input by the dealer (or operator), the game engine 210 checks if it is a legal bet and if so, the game engine 210 stores that new bet as the committed bet for the player. In some implementations, the game engine 210 subtracts the new bet from the player's stack and stores the previous bet in case action is reverted. In some implementations, the game engine 210 moves the current action to the next player seated clockwise.

In some implementations, a revert (or reversal action) can occur when the game engine 210 determines that a changed prior action would create a legal new outcome. For example, if previously five chips were read as a call but then the player adds another set of five chips, since ten chips is a legal raise, the game engine 210 can reverse and update the action. However, if the player adds only two chips, since the total number of seven chips is not the legal raise, the game engine 210 can identify such action not as the legal raise.

In some implementations, if an “all in” card tag is detected on a player antenna 204a through 204i, the game engine 210 sets the player's bet to the sum of the player's stack size and whatever bet the player has already committed. If a subsequent action is on this player, the game engine 210 skips the action and stores the player's bets committed to the pot separately to calculate split pots at the end of the hand.

In some implementations, if a player's hole cards are detected in the center of the table (e.g., by the antennae 204j, 204k, and 204l associated with the antenna positions 10 through 12), the game engine 210 marks these cards as mucked cards and folds the player when action gets to that player.

In some implementations, if the street is POSTFLOP, the game engine 210 waits until any player bets (for example, not only the player with current action), and the game engine 210 checks that player if the bet is legal. In some implementations, if a new community card and a required number of burn cards are detected in the center of the table (e.g., by the antennae 204j, 204k, and 204l associated with the antenna positions 10 through 12), the game engine 210 checks through all players for that street.

In some implementations, the game engine 210 stores the actions in the hand history for checks, bets, and folds, to later send to the database 216 (that can be, for example, in the cloud) the data packets including this data. In some implementations, this data can be used, for example, to revert the action.

In some implementations, if a player who already performed an action changes the player's bet or the chips are moved, the game engine 210 checks if the new chips create a legal bet, and if so, the game engine 210 reverses all previous actions in the stored hand history and sets the new bet.

In some implementations, when all players who are in the hand have the same bet or are “all in”, action is considered to be complete. In some implementations, if action is complete and the community cards are read but there are still bets on the player antennae 204a through 204i from the previous street, the game engine 210 marks these chips, notifies the dealer on the tablet 144 (FIG. 1A). For example, the game engine 210 requests the dealer to confirm whether it is a bet in the dark and the game engine 210 sends a command, by the communication handler 208, to the LED microcontroller 218 to flash the LED lights 220 on the table. If the game engine 210 confirms that it is not a bet in the dark, the game engine 210 ignores the chips in future bets.

In some implementations, if a bet is placed as a single chip that could be a legal call or raise, the game engine 210 notifies the dealer by, for example, sending a command to the dealer tablet 144 (FIG. 1A) to initiate a call or raise button notification on the tablet 144 and send a command to the LED microcontroller 218 to flash the LED lights 220 on the table. In some implementations, the game engine 210 sends the same commands to the dealer tablet 144 and the LED microcontroller 218 for “all in” spots with a one chip call to prevent accidental calls.

In some implementations, when a new card that is not a hole card or a current community card is detected in the center of the table (by for example, antennae 204j, 204k, and 204/associated with the antenna positions 10 through 12), the game engine 210 marks that new card as the burn card. In some implementations, if another new card is detected, the game engine 210 sets that card as the community card (the game engine 210 waits, for example, for three on the flop and one on the turn and river).

In some implementations, if there are multiple boards configured or the board is run multiple times in an “all in” spot, the game engine 210 keeps track of the current board index to store the cards separately. In some implementations, when waiting for the street's community cards is completed, the game engine 210 sets the current street to the next street and resets an action to the player in the hand after the dealer button position. In some implementations, on the river, if there are no chips in the pot, the game engine 210 assumes the hand checked through and assigns the winner based on evaluating the board and the hole cards. In some implementations, the game engine 210 sets the game to the CLEARING mode.

In some implementations, if at any point there is only one player left in the hand, the game engine 210 assigns that one player as the winner. The game engine 210 increases the player's stack by a percentage of the pot that player won. The game engine 210 sets the game to the CLEARING mode.

In some implementations, if the community cards are manually changed by an operator, the game engine 210 pauses reading from the table antennae 204a through 204l to prevent future misreads. In some implementations, the game engine 210 executes the same procedure if there is a revert from the current street to a previous street. In some implementations, after every folding action and community card placement, the game engine 210 recalculates the hand equities.

In some implementations, if broadcast settings are enabled, the camera switcher sends a command to switch the camera to face the player whose action is on. In some implementations, if the burn card is detected and not the board cards, the camera switcher switches to the board camera(s). In some implementations, if the action is complete (for example, all bets of players in the hand are the same or the player is “all in”), then the camera switcher instructs an overview camera to show all players. The LED microcontroller 218 sends the command to the LED lights 220 to follow the same or substantially the same procedure.

In some implementations, during the PLAY mode, the LED microcontroller 218 can instruct the following light modes to the LED lights 220: off, red, green, blue, blinking white, all yellow, and all green. For example, the “off” mode of the LED light 220 indicates that a player is not in hand. For example, the “red” mode of the LED light 220 indicates that a player is in hand. For example, the “green” mode of the LED light 220 indicates that a player is in hand and action is on the player. For example, the “blue” mode of the LED light 220 indicates that a player is “all in”. For example, the “blinking white” mode of the LED light 220 indicates that a dealer needs to select a choice on the dealer screen 144 (FIG. 1A), for example, to click a certain button on the dealer screen 144. For example, the “all yellow” mode of the LED light 220 indicates that the game engine 210 is waiting for the burn card. For example, the “all green” mode of the LED light 220 indicates that the game engine 210 is waiting for the community cards.

Reference is now made to the CLEARING Mode. In some implementations, the game engine 210 shows hand results and stores them in the database 216 (that can be, for example, in the cloud). In some implementations, at this stage, the dealer or operator can manually revert the hand if the action is incorrect or if the winner was incorrectly assigned. In some implementation, when a “cut card” is recognized as being present in the center of the table (e.g., by the antennae 204j, 204k, and 204l associated with the antenna positions 10 through 12), or all cards and chips are removed from the antennae 204a through 204l, the game engine 210 resets all variables, sends the hand history with player and game metadata to the database 216 (that can be, for example, in the cloud), and sets the game to the STANDBY mode.

In some implementations, during the CLEARING mode, the LED microcontroller 218 can instruct the “red” light mode to the LED lights 220. For example, the “red” mode of the LED light 220 indicates that a hand is complete and the game engine 210 is waiting for the table to be cleared.

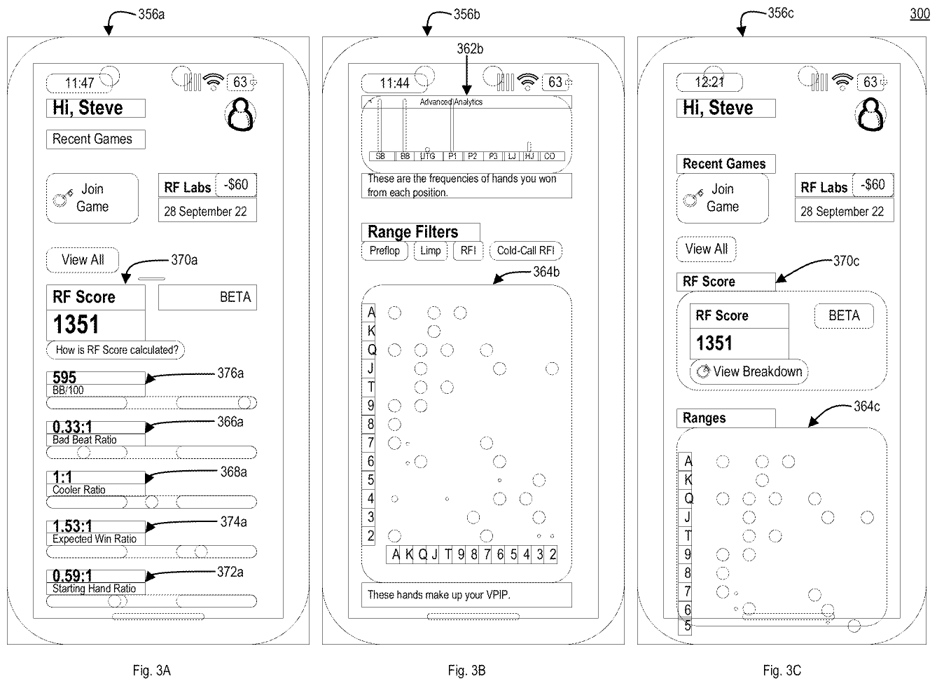

FIGS. 3A-3C provide a more detailed view of certain components of an RF enabled system 300, according to another embodiment of the present disclosure. The RF enabled system 300 may be identical to or similar in some respect to the RF enabled system 100 of FIGS. 1A-1C. Accordingly, like features may be designated with like reference numerals, with the leading digits incremented to “3”. Relevant disclosure set forth above regarding similarly identified features thus may not be repeated hereafter. Moreover, specific features of the RF enabled system 300 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the RF enabled system 300. Any suitable combination of the features and variations of the same described with respect to the RF enabled system 100 can be employed with the RF enabled system 300, and vice versa. This pattern of disclosure applies equally to further embodiments depicted in subsequent figures and described hereafter.

In some implementations, the Graphical User Interface (GUI) of the player companion application 140 (FIG. 1A) can be run on a user device 356. In some implementations, the system processor 106 and/or the game engine 110 (FIG. 1A) can perform data analytics and insights that can be displayed, for example, on a user device 356. According to some implementations, the game engine 110 (FIG. 1A) can track the following gameplay data: player information, hole cards, bet sizing, action, equity, timestamps, positioning, hand number, community cards, mucked cards, and the like. In some implementations, this data is collected locally in real-time, and after each hand is sent to the backend (that can be, for example, in the cloud). In some implementations, the computing system 250 (FIG. 2) parses and analyzes this data in the backend. In some implementations, the hand, session, player data, and analytics serverless function 136 (FIG. 1A) and the player companion application 140 (FIG. 1A) can make the API calls between each other using, for example, tRPC, to transfer this data.

In some implementations, the computing system 250 can display to each player specific statistics of the player's gameplay. For example, the computing system 250 can display hands played, hands won, percentage of a voluntarily put amount in pot (VPIP), percentage of a pre-flop raise (PFR), percentage of an aggression frequency (AFQ), percentage of a “went to showdown” (WTSD), big blinds won per hour (BB/Hour), and percentage of limping, C-Bet, 3-Bet, 4-Bet, and the like.

In some implementations, the computing system 250 can display hand ranges filtered by position, bet size, and number of players. The hand ranges can illustrate, for example, each hand that was received and how many times the hand was played post-flop and was won.

In some implementations, the computing system 250 can display distribution charts 364 filtered by bet size, time played, number of players, streets played, hands won. The distribution charts 364 can illustrate, for example, percentages of each win and loss based on each filter.

In some implementations, the computing system 250 can display bad beats 366 that can include, for example, the hands where equity of the player's hand increased or decreased by over 50 percent based on a community card coming out.

In some implementations, the computing system 250 can display coolers 368 that can include losing with a two-pair or more on the flop, three of a kind or better on the turn, flush, or better on the river. The coolers 368 can illustrate, for example, edge cases for pre-flop and river hands.

In some implementations, the computing system 250 can display statistics accumulated and used to determine an RF Score 370 and specific “luck factors”. In some implementations, “luck factors” can include an expected win factor 374, a starting hand factor 372, a cooler factor 368, and a bad beat factor 366. The RF SCORE 370 can be such as those supplied by RF Labs, Inc. of Atlanta, U.S.A.

For example, the expected win factor 374 can include percentage of instances won more or less than what is expected by a Monte Carlo simulation. For example, the starting hand factor can include an average ranking of hands received in comparison to an arbitrary ranking of each hand. For example, the cooler factor 368 can include a ratio of coolers won versus lost. For example, the bad beat factor 366 can include a ratio of bad beats (BB) won versus lost.

In some implementations, a Monte Carlo algorithm could be based on artificial intelligence or a machine-learning model. For example, the machine-learning model may be trained to identify particular data of the dataset (e.g., type of a game, statistics of the players' gameplays, and the like) and output a prediction. In some examples, a machine-learning model may be trained to select the template that matches the received dataset. In various arrangements, selecting the template can include utilizing a machine learning algorithm (e.g., a neural network, convolutional neural network, recurrent neural network, linear regression model, and sparse vector machine). The one or more processing circuits can input data into the machine learning model and receive a template from the model indicating if there is a match. In some arrangements, the one or more processing circuits may utilize various algorithms to execute the matching algorithm for a plurality of the datasets to select the appropriate template.

In some implementations, the RF score 370 can include a cumulation of luck factors and results (for example, BB divided by 100, generally referenced by a 376 numeral) based on player's total statistics on a scale of 0 to 2000. In some implementations, an algorithm for calculating the RF Score 370 can change but the general usage and cumulation of factors can stay the same.

In some implementations, a player can have access to raw hand histories that include details from the hand listed as a transcript and/or as a video that they can view and share. In some implementations, a player can view the player information and follow other players. In some implementations, the computer system 250 (FIG. 2) can notify the player regarding the data analytics (e.g., 362) and insights and/or common games. In some implementations, community features are included in the player companion application 140 (FIG. 1A) to build player networks and enable leaderboards, clubs, and sharing the data analytics and insights.

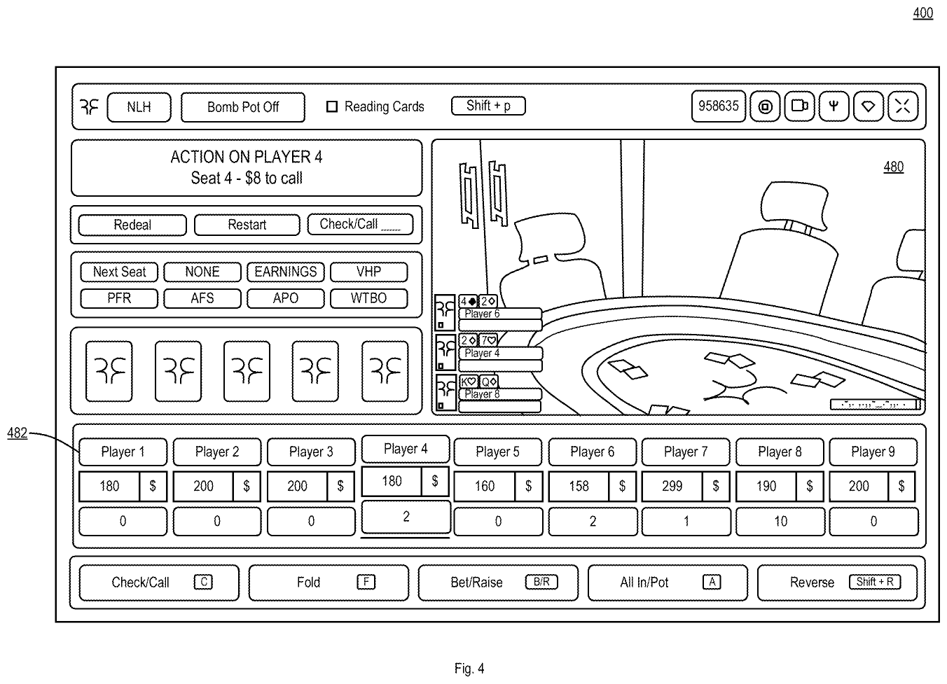

FIG. 4 provides a more detailed view of certain components of an RF enabled system 400, according to another embodiment of the present disclosure. The RF enabled system 400 may be identical to or similar in some respect to the RF enabled system 100 of FIG. 1A. Accordingly, like features may be designated with like reference numerals, with the leading digits incremented to “4”. Relevant disclosure set forth above regarding similarly identified features thus may not be repeated hereafter. Moreover, specific features of the RF enabled system 400 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the RF enabled system 400. Any suitable combination of the features and variations of the same described with respect to the RF enabled system 100 can be employed with the RF enabled system 400, and vice versa. This pattern of disclosure applies equally to further embodiments depicted in subsequent figures and described hereafter.

Reference is now made to an automated live streaming of the RF enabled system 400. In some implementations, the RF enabled system 400 enables a player or an business enterprise where the RF enabled system 400 is commissioned to record or stream the player's games. In some implementations, the automated live streaming benefits individual players and business operators running the RF enabled system 400 for marketing and social media purposes.

For example, by tracking the current state of the game, the computer system 250 (FIG. 2) sends the data packets to a graphic overlay system. In some implementations, the graphic overlay illustrates current player names and profile pictures, seat numbers 482, hole cards, bet size, stack, pot size, community cards, hand number, hand history, and the like. In some implementations, between hands and during important spots, viewers can also see statistics collected throughout the game and recorded periodically. In some implementations, customizations can be performed to modify styling and/or add features such as a split-screen view and important hand history.

In some implementations, the manually tracked system enables cards to be read from the table, bet sizes can be manually input by a manual tracker 148 (FIG. 1A). In some implementations, the RFID tag associated with the dealer button position and/or the cut card can control the current game state.

In some implementations, when actions are either manually input or automatically tracked from the RFID enabled tags 101 associated with the chips, the camera switcher of a broadcasting system can control current camera angles. For example, the camera switcher can send a command to the camera to switch to a view 480 where the current player action is on, as illustrated in FIG. 4, or where the community cards are between streets.

In some implementations, the broadcasting system of the RF enabled system 400 can be compatible with a broadcasting software, such as, for example, Open Broadcaster Software (OBS). Using a broadcasting software, the broadcasting system can be configured such that each scene has a camera and a WebSocket plugin is used to automatically switch between the scenes. In some implementations, the broadcasting system is also compatible with camera switchers that have hardware such as, for example, the Blackmagic Design ATEM® switcher. In some implementations, the broadcasting software, through the network 254, can set the program and preview input of the camera switcher, and control audio and Keyer states to enable effects.

FIGS. 1A-1C, 2, 3A-3C and 4 illustrate the RF enabled system 100, 200, 300, and 400 implemented as a poker game. However, one of ordinary skill in the art appreciates that the RF enabled system 100, 200, 300, and 400 may be implemented as any other card and/or chip game (for example, blackjack, baccarat, pontoon, red dog, etc.).

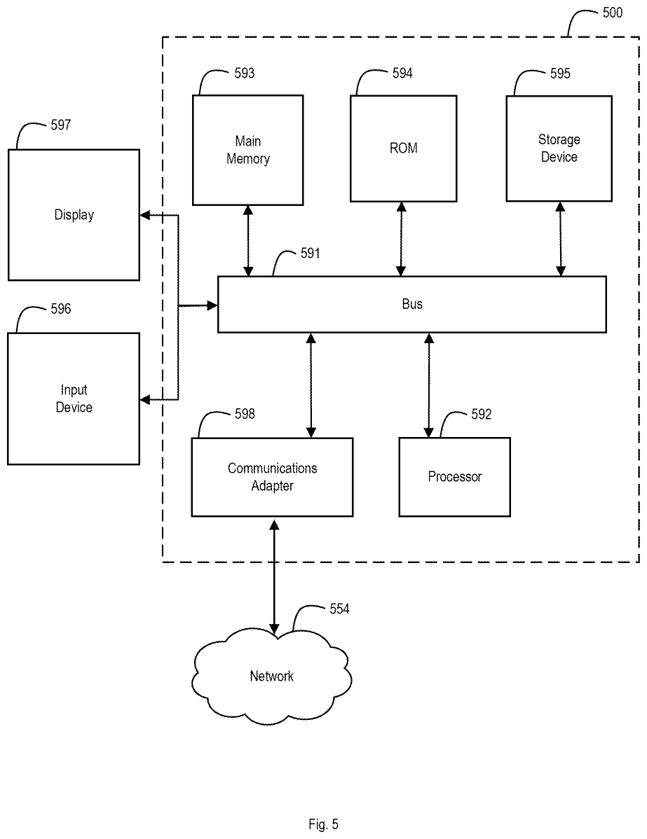

Referring now to FIG. 5, a depiction of a computer system 500 is shown. The computer system 500 that can be used, for example, to implement a computing environment 250, the game engine 110, the system processor 106, the communication handler 108, the WebSocket handler 112, the MQTT handler 114, the user device 256, and/or various other example systems described in the present disclosure. The computer system 500 includes a bus 591 or other communication component for communicating information and a processor 592 coupled to the bus 591 for processing information. The computer system 500 also includes main memory 593, such as a random-access memory (RAM) or other dynamic storage device, coupled to the bus 591 for storing information, and instructions to be executed by the processor 592. Main memory 593 can also be used for storing position information, temporary variables, or other intermediate information during execution of instructions by the processor 592. The computer system 500 may further include a read only memory (ROM) 594 or other static storage device coupled to the bus 591 for storing static information and instructions for the processor 592. A storage device 595, such as a solid-state device, magnetic disk, or optical disk, is coupled to the bus 591 for persistently storing information and instructions.

The computer system 500 may be coupled via the bus 591 to a display 597, such as a liquid crystal display, or active matrix display, for displaying information to a user. An input device 596, such as a keyboard including alphanumeric and other keys, may be coupled to the bus 591 for communicating information, and command selections to the processor 592. In another arrangement, the input device 596 has a touch screen display 597. The input device 596 can include any type of biometric sensor, a cursor control, such as a mouse, a trackball, or cursor direction keys, for communicating direction information and command selections to the processor 592 and for controlling cursor movement on the display 597.

In some arrangements, the computer system 500 may include a communications adapter 598, such as a networking adapter. Communications adapter 598 may be coupled to bus 591 and may be configured to enable communications with a computing or communications network 554 and/or other computing systems. In various illustrative arrangements, any type of networking configuration may be achieved using communications adapter 598, such as wired (e.g., via Ethernet), wireless (e.g., via Wi-Fi, Bluetooth), satellite (e.g., via GPS) pre-configured, ad-hoc, LAN, and WAN.

According to various arrangements, the processes that effectuate illustrative arrangements that are described herein can be achieved by the computer system 500 in response to the processor 592 executing an arrangement of instructions contained in main memory 593. Such instructions can be read into main memory 593 from another computer-readable medium, such as the storage device 595. Execution of the arrangement of instructions contained in main memory 593 causes the computer system 500 to perform the illustrative processes described herein. One or more processors in a multi-processing arrangement may also be employed to execute the instructions contained in main memory 593. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 5, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 5 as singular, stand-alone devices, one of ordinary skill in the art will appreciate that, in some arrangements, the computer system 500 may include virtualized systems and/or system resources. For example, in some arrangements, the computer system 500 may be a virtual switch, virtual router, virtual host, or virtual server. In various arrangements, computer system 500 may share physical storage, hardware, and other resources with other virtual machines. In some arrangements, virtual resources of the network 554 (e.g., network 254 of FIG. 2) may include cloud computing resources such that a virtual resource may rely on distributed processing across more than one physical processor, distributed memory, etc.

While this specification contains many specific implementation details and/or arrangement details, these should not be construed as limitations on the scope of any inventions or of what may be claimed, but rather as descriptions of features specific to particular implementations and/or arrangements of the systems and methods described herein. Certain features that are described in this specification in the context of separate implementations and/or arrangements can also be implemented and/or arranged in combination in a single implementation and/or arrangement. Conversely, various features that are described in the context of a single implementation and/or arrangement can also be implemented and arranged in multiple implementations and/or arrangements separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Additionally, features described with respect to particular headings may be utilized with respect to and/or in combination with illustrative arrangement described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying FIGS. do not necessarily require the particular order shown, or sequential order, to achieve desirable results.

In certain circumstances, multitasking and parallel processing may be advantageous. Moreover, the separation of various system components in the implementations and/or arrangements described above should not be understood as requiring such separation in all implementations and/or arrangements, and it should be understood that the described program components and systems can generally be integrated together in a single software product or packaged into multiple software products.

Having now described some illustrative implementations, implementations, illustrative arrangements, and arrangements it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements and features discussed only in connection with one implementation and/or arrangement are not intended to be excluded from a similar role in other implementations or arrangements.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations and/or arrangements consisting of the items listed thereafter exclusively. In one arrangement, the systems and methods described herein consist of one, each combination of more than one, or all of the described elements, acts, or components.

Any references to implementations, arrangements, or elements or acts of the systems and methods herein referred to in the singular may also embrace implementations and/or arrangements including a plurality of these elements, and any references in plural to any implementation, arrangement, or element or act herein may also embrace implementations and/or arrangements including only a single element. References in the singular or plural form are not intended to limit the presently disclosed systems or methods, their components, acts, or elements to single or plural configurations. References to any act or element being based on any information, act or element may include implementations and/or arrangements where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

Any arrangement disclosed herein may be combined with any other arrangement, and references to “an arrangement,” “some arrangements,” “an alternate arrangement,” “various arrangements,” “one arrangement” or the like are not necessarily mutually exclusive and are intended to indicate that a particular feature, structure, or characteristic described in connection with the arrangement may be included in at least one arrangement. Such terms as used herein are not necessarily all referring to the same arrangement. Any arrangement may be combined with any other arrangement, inclusively or exclusively, in any manner consistent with the aspects and arrangements disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to controlling the display of content of information resources, the systems and methods described herein can include applied to other environments. The foregoing implementations and/or arrangements are illustrative rather than limiting of the described systems and methods. Scope of the systems and methods described herein is thus indicated by the appended claims, rather than the foregoing description, and changes that come within the meaning and range of equivalency of the claims are embraced therein.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, and/or sensors. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

What is claimed is:

1. A Radio Frequency (RF) enabled card game table, comprising:
an RF reader associated with the game table receiving RF signals transmitted by a plurality of RF tags associated with playing cards and chips; and
a processor communicatively coupled to the RF reader, the processor rendering a game state from the RF signals, forming and transmitting, via an Application Programming Interface (API), a packet including the rendered game state,
wherein RF signals received from an RF tag having a Received Signal Strength Indicator (RSSI) lower than a predetermined threshold are ignored.

2. The game table of claim 1, wherein the RF signals received from the RF tag having the RSSI lower than the predetermined threshold are ignored in response to at least one of a surrounding noise level interfering with transmission of the RF signals or the RF tag being disposed at a predetermined distance from the RF readers.

3. The game table of claim 1, further comprising:
an LED light associated with a player position,
wherein the processor controls the LED light based on the rendered game state.

4. The game table of claim 1, wherein the processor selectively shares with other players player data extracted from the received packet.

5. The game table of claim 1, further comprising:
a camera communicatively coupled to the processor controlling a camera angle.

6. The game table of claim 1, further comprising:
an RF shielding fabric.

7. The game table of claim 1, wherein the RF reader further comprises an RF antenna and wherein the RF antenna is spaced apart from other components of the RF reader.

8. The game table of claim 1, wherein the processor is configured to revert a current game state to a prior game state in response to at least one of a user initiating a manual action or the user action creating a legal new outcome.

9. The game table of claim 1, wherein the processor is configured to pause RF reading in response to at least one of a card placed at a center of the game table being manually changed by a user or a reversal from a current game state to a previous game state.

10. A Radio Frequency (RF) enabled card game table, comprising:
an RF reader associated with the game table receiving RF signals transmitted by a plurality of RF tags associated with playing cards and chips; and
a processor communicatively coupled to the RF reader, the processor rendering a game state from the RF signals, forming and transmitting, via an Application Programming Interface (API), a packet including the rendered game state,
wherein RF signals received from an RF tag not affecting the rendered game state are ignored.

11. The method of using a Radio Frequency (RF) enabled card game table, the method comprising:
receiving, by an RF reader, RF signals transmitted by a plurality of RF tags associated with playing cards and chips;
ignoring RF signals received from an RF tag having a Received Signal Strength Indicator (RSSI) lower than a predetermined threshold;
rendering, by a processor, a game state from the RF signals having the RSSI above the predetermined threshold;
forming, by the processor, a packet including the rendered game state; and
transmitting, by the processor, via an Application Programming Interface (API), the formed packet.

12. The method of claim 11, further comprising:
ignoring the RF signals received from the RF tag having the RSSI lower than the predetermined threshold in response to at least one of interfering, by a surrounding noise level, with transmission of the RF signals or disposing the RF tag at a predetermined distance from the RF readers.

13. The method of claim 11, further comprising:
controlling, by the processor, an LED light associated with a player position in response to the rendered game state.

14. The method of claim 11, further comprising:
selectively sharing, by the processor, with other players player data extracted from the received packet.

15. The method of claim 11, further comprising:
displaying, by a television screen communicatively coupled to the processor, the rendered game state.

16. The method of claim 11, further comprising:
controlling an angle of a camera communicatively coupled to the processor.

17. The method of claim 11, wherein the RF reader further comprises an RF antenna.

18. The method of claim 17, wherein the RF antenna is spaced apart from other components of the RF reader.

19. The method of claim 11, further comprising:
reverting, by the processor, a current game state to a prior game state in response to at least one of a user initiating a manual action or the user action creating a legal new outcome.

20. The method of claim 11, further comprising:
pausing, by the processor, RF reading in response to at least one of a card placed at a center of the game table being manually changed by a user or a reversal from a current game state to a previous game state.
